(19) United States
(12) Patent Application Publication
(10) Pub. No.: US 2017/0038871 A1
(43) Pub. Date: Feb. 9, 2017

(54) COLOR FILM SUBSTRATE, TOUCH DISPLAY AND METHOD FOR MANUFACTURING THE COLOR FILM SUBSTRATE

(71) Applicants: Boe Technology Group Co. LTD., Beijing (CN); Chengdu Boe Optoelectronics Technology Group Co., LTD, Beijing (CN)

(72) Inventors: Gang ZHOU, Beijing (CN); Wei HU, Beijing (CN); Hua TIAN, Beijing (CN); Zailong MO, Beijing (CN)

(21) Appl. No.: 14/907,237

(22) PCT Filed: Aug. 12, 2015
(86) PCT No.: PCT/CN2015/086768

§ 371 Date: Jan. 22, 2016

(30) Foreign Application Priority Data
Mar. 16, 2015 (CN) 201510114502.1

(51) Int. Cl. G06F 3/041; G02F 1/1335; G02F 1/1333

(52) U.S. Cl. CPC G06F 3/0412; G06F 3/0416; G02F 1/13338; G02F 1/133514; G02F 1/133512; G06F 2203/04103

(57) ABSTRACT

The embodiments of the present invention disclose a color film substrate, a touch display and a method for manufacturing the color film substrate, to improve the display effect of the touch display and improve the touch sensitivity of the touch display. The color film substrate comprises a basal substrate, a touch electrode, a color filter and a black matrix, wherein: the touch electrode is located on an outer side of the basal substrate, at least one of the color filter and the black matrix covers an outer side of the touch electrode. Since at least one of the color filter and the black matrix covers an outer side of the touch electrode, the stripe pattern of the touch electrode can be alleviated or eliminated from the screen; therefore, the solution can effectively improve the display effect of the touch display. Moreover, since the touch electrode is located on an outer side of the basal substrate, the touch sensitivity of the touch display is not affected by the thickness of the basal substrate, the solution can also improve the touch sensitivity of the touch display.

### FIELD OF THE INVENTION

The present invention relates to the field of touch display technology, particularly to a color film substrate, a touch display and a method for manufacturing the color film substrate.

### BACKGROUND OF THE INVENTION

With the rapid development of display technology, the touch display has been gradually throughout the life of people; users of the touch display raise higher requirements for the display quality and touch sensitivity of the touch display. However, for the existing touch display, the stripe pattern of the touch electrode can be obviously seen from the screen, the display effect is poor, the touch effect of some touch displays is not ideal enough; these problems seriously impact on the user experience.

### SUMMARY OF THE INVENTION

An object of the embodiments of the present invention is to provide a color film substrate, a touch display and a method for manufacturing the color film substrate, to improve the display effect of the touch display and improve the touch sensitivity of the touch display.

An embodiment of the present invention provides a color film substrate, comprising a basal substrate, a touch electrode, a color filter and a black matrix, wherein:

the touch electrode is located on an outer side of the basal substrate, at least one of the color filter and the black matrix covers an outer side of the touch electrode.

When the color film substrate provided by the embodiment of the invention is applied in a touch display, since at least one of the color filter and the black matrix covers an outer side of the touch electrode, the stripe pattern of the touch electrode can be alleviated or eliminated from the screen; therefore, the solution can effectively improve the display effect of the touch display. Moreover, since the touch electrode is located on an outer side of the basal substrate, the touch sensitivity of the touch display is not affected by the thickness of the basal substrate, the solution can also improve the touch sensitivity of the touch display.

In a specific structure of the color film substrate, the color filter is located on the outer side of the touch electrode; the black matrix is located on the outer side of the color filter.

In a specific structure of the color film substrate, the color filter is located on the outer side of the basal substrate; the touch electrode is located on the outer side of the color filter; the black matrix covers the outer side of the touch electrode. This solution can eliminate the stripe pattern of the touch electrode from the screen, thereby further improving the display effect of the touch display.

In a specific structure of the color film substrate, the color filter is located on an inner side of the basal substrate; the black matrix covers the outer side of the touch electrode. This solution can also eliminate the stripe pattern of the touch electrode from the screen, thereby further improving the display effect of the touch display.

In a specific structure of the color film substrate, the black matrix comprises a first shading layer and a second shading layer, wherein:

the first shading layer covers the outer side of the touch electrode;

the second shading layer is located on an inner side of the basal substrate;

the color filter is located on an inner side of the basal substrate; and the boundary area of the color filter is shaded by the second shading layer.

In particular, the color film substrate further comprises: a spacer located on an inner side of a structure formed with the basal substrate, the touch electrode, the color filter and the black matrix; and a protective layer located on an outer side of the structure formed with the basal substrate, the touch electrode, the color filter and the black matrix.

An embodiment of the present invention further provides a touch display comprising a color film substrate described in any one of the above mentioned embodiments. The touch display has a better display effect and a higher touch sensitivity.

An embodiment of the present invention further provides a method for manufacturing a color film substrate, comprising:

forming a touch electrode located on an outer side of a basal substrate;

forming a color filter and/or a black matrix covering an outer side of the touch electrode.

When the color film substrate manufactured with the method is applied in a touch display, the display effect and the touch sensitivity of the touch display can be improved effectively.

Optionally, forming a color filter and/or a black matrix covering an outer side of the touch electrode is forming a color filter covering an outer side of the touch electrode; the method further comprises:

forming a spacer located on an inner side of the basal substrate;

forming a black matrix located on an outer side of the color filter;

forming a protective layer covering the outer side of the color filter and the black matrix;

wherein at least one of the color filter and the black matrix covers the outer side of the touch electrode.

Optionally, forming a touch electrode located on an outer side of a basal substrate comprises forming a color filter located on the outer side of the basal substrate and forming a touch electrode located on an outer side of the color filter; forming a color filter and/or a black matrix covering an outer side of the touch electrode is forming a black matrix covering an outer side of the touch electrode; the method further comprises:

forming a spacer located on an inner side of the basal substrate;

forming a protective layer covering the outer side of the color filter and the black matrix.

Optionally, forming a color filter and/or a black matrix covering an outer side of the touch electrode is forming a black matrix covering an outer side of the touch electrode; the method further comprises:

forming a color filter located on an inner side of the basal substrate;

forming a spacer located on an inner side of the color filter;

forming a protective layer covering the outer side of the basal substrate and the black matrix.

Optionally, forming a color filter and/or a black matrix covering an outer side of the touch electrode is forming a first shading layer covering an outer side of the touch electrode; the method further comprises:

forming a second shading layer located on an inner side of the basal substrate;

forming a color filter located on an inner side of the second shading layer, the boundary area of the color filter being shaded by the second shading layer;

forming a spacer located on an inner side of the color filter;

forming a protective layer covering the outer side of the basal substrate and the first shading layer.

### BRIEF DESCRIPTION OF THE DRAWINGS

FIG. 1 is a structural schematic diagram of a color film substrate provided by a first embodiment of the present invention;

FIG. 2 is a structural schematic diagram of a color film substrate provided by a second embodiment of the present invention;

FIG. 3 is a structural schematic diagram of a color film substrate provided by a third embodiment of the present invention;

FIG. 4 is a structural schematic diagram of a color film substrate provided by a fourth embodiment of the present invention;

FIG. 5 is a structural schematic diagram of a color film substrate provided by a fifth embodiment of the present invention;

FIG. 6 is a structural schematic diagram of a color film substrate provided by a sixth embodiment of the present invention; and

FIG. 7 is a flow diagram of a method for manufacturing a color film substrate provided by a seventh embodiment of the present invention.

### REFERENCE SIGNS

1—basal substrate; 2—touch electrode; 3—color resin; 4—black matrix; 41—first shading layer; 42—second shading layer; 5—spacer; 6—protective layer.

### DETAILED DESCRIPTION OF THE INVENTION

To improve the display effect and the touch sensitivity of the touch display, the embodiments of the present invention disclose a color film substrate, a touch display and a method for manufacturing the color film substrate. To make the objects, solutions and advantages of the present invention more clear, the present invention is illustrated in detail with the following embodiments.

An embodiment of the present invention provides a color film substrate, comprising a basal substrate, a touch electrode, a color filter and a black matrix, wherein: the touch electrode is located on an outer side of the basal substrate, at least one of the color filter and the black matrix covers an outer side of the touch electrode.

In addition to the above mentioned structure, the color film substrate typically comprises: a spacer located on an inner side of a structure formed with the basal substrate, the touch electrode, the color filter and the black matrix; and a protective layer located on an outer side of the structure formed with the basal substrate, the touch electrode, the color filter and the black matrix.

In the embodiments of the present invention, the “outer side” can be construed as a side departing from the liquid crystal layer; the “inner side” can be construed as a side facing the liquid crystal layer. “covering an outer side of the touch electrode” can be construed as being located on an outer side of the touch electrode and shading the touch electrode.

The specific type of the basal substrate is not limited herein; for example, it can be a glass basal substrate or a resin basal substrate, etc. The touch electrode can comprise a driving electrode and/or a sensing electrode, which is used as a main structure for realizing the function of touch control. The touch electrode is typically made from transparent conductive materials, such as indium tin oxide (ITO) and so on.

The color resin can typically comprise R (red) resin, G (green) resin and B (blue) resin, which are mainly used for generating RGB primary colors; the RGB primary colors are blended with different proportions, thereby presenting various colors and enabling the thin film transistor liquid crystal display to display full color. It should be noted that in the field of the liquid crystal display, the color resin is not limited to RGB colors (Red Green Blue); it can also comprise various color combinations such as RGBW (Red Green Blue White), RGBY (Red Green Blue Yellow), CMYK (Cyan Magenta Yellow Black) and so on. Moreover, those skilled in the art can understand that though the “color resin” is used in the embodiments of the present invention to indicate the color filter with filtering function, the color filter can also be formed with materials such as color photoresist or color ink.

As shown in FIG. 1, in a color film substrate provided by a first embodiment of the present invention:

the spacer 5 is located on the inner side of the basal substrate 1;

the touch electrode 2 is located on the outer side of the basal substrate 1;

the color resin 3 is located on the outer side of the touch electrode 2;

the black matrix 4 is located on the outer side of the color resin 3;

the protective layer 6 covers the outer side of the color resin 3 and the black matrix 4;

wherein a part of the touch electrode 2 is covered by the color resin 3, and a part of the touch electrode 2 is covered by the color resin 3 and the black matrix 4.

The color resin 3 and the black matrix 4 have function of shading light, which can eliminate or reduce the stripe pattern of the touch electrode 2 from the screen, thereby alleviating the visual effect of the stripe pattern; therefore this solution can improve the display effect of the touch display effectively.

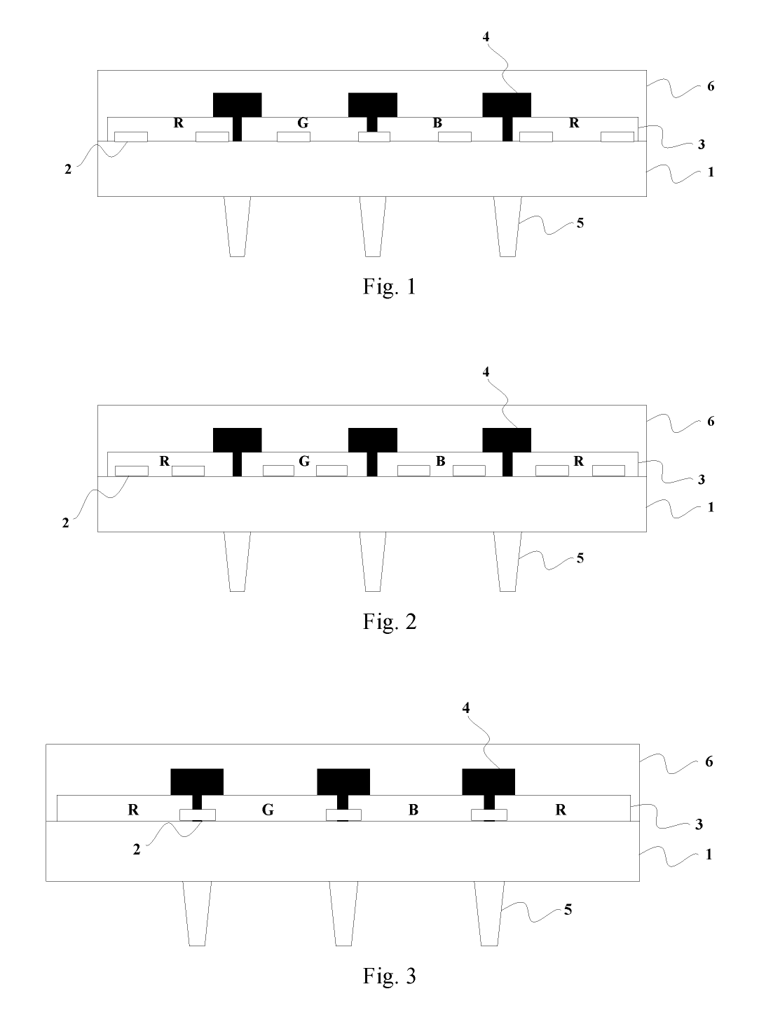

As shown in FIG. 2, in a color film substrate provided by a second embodiment of the present invention:

the spacer 5 is located on the inner side of the basal substrate 1;

the touch electrode 2 is located on the outer side of the basal substrate 1;

the color resin 3 is located on the outer side of the touch electrode 2;

the black matrix 4 is located on the outer side of the color resin 3;

the protective layer 6 covers the outer side of the color resin 3 and the black matrix 4;

wherein the touch electrode 2 is completely covered by the color resin 3.

Though the shading light function of the color resin 3 is not as good as the black matrix 4, the color resin 3 can still shade the stripe pattern of the touch electrode 2, thereby alleviating the visual effect of the stripe pattern from the screen; therefore this solution can also improve the display effect of the touch display effectively.

As shown in FIG. 3, in a color film substrate provided by a third embodiment of the present invention:

the spacer 5 is located on the inner side of the basal substrate 1;

the touch electrode 2 is located on the outer side of the basal substrate 1;

the color resin 3 is located on the outer side of the touch electrode 2;

the black matrix 4 is located on the outer side of the color resin 3;

the protective layer 6 covers the outer side of the color resin 3 and the black matrix 4;

wherein the touch electrode 2 is located at the boundary area of adjacent color resins 3, and is covered by the color resin 3 and the black matrix 4.

The black matrix 4 has a good shading light function, the stripe pattern of the touch electrode 2 thus can be shaded, thereby eliminating the visual effect of the stripe pattern from the screen; therefore this solution can improve the display effect of the touch display effectively.

In the above mentioned three embodiments, the black matrix and the color resin can also be arranged in a same layer; the black matrix can be located at the boundary area of adjacent color resins; at least one of the color resin and the black matrix covers an outer side of the touch electrode. Similar with the effect of the above mentioned structure, the color film substrate with this structure can eliminate or reduce the stripe pattern of the touch electrode from the screen, thereby improving the display effect of the touch display effectively.

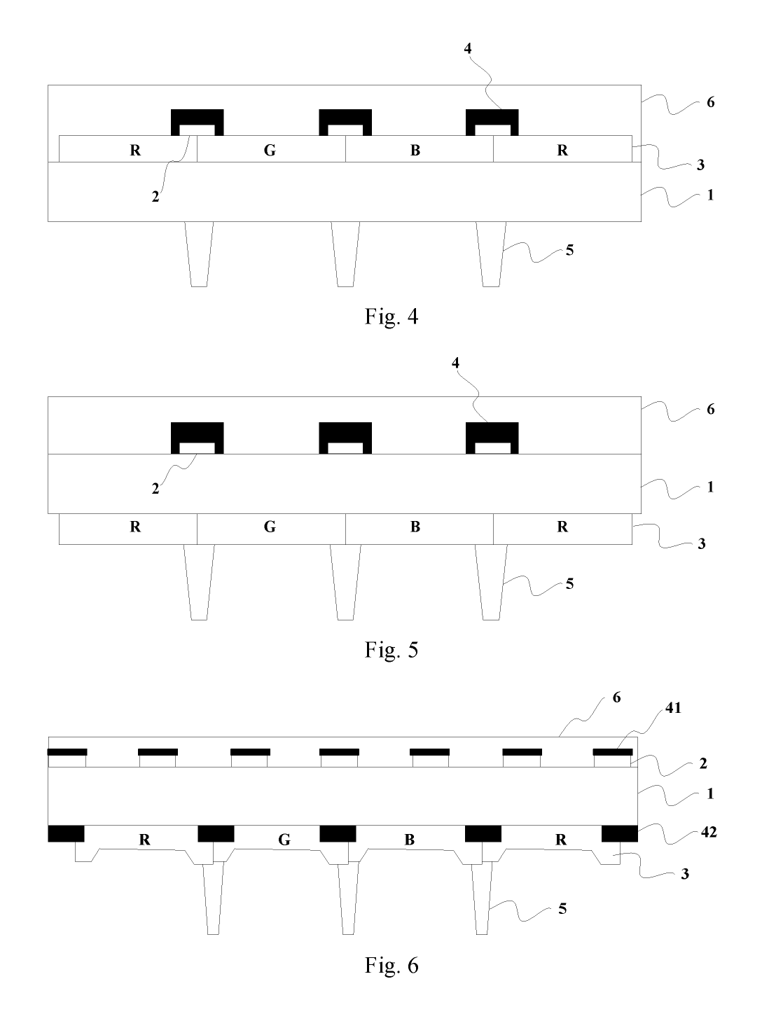

As shown in FIG. 4, in a color film substrate provided by a fourth embodiment of the present invention:

the spacer 5 is located on the inner side of the basal substrate 1;

the color resin 3 is located on the outer side of the basal substrate 1;

the touch electrode 2 is located on the outer side of the color resin 3;

the black matrix 4 is located on the outer side of the touch electrode 2;

the protective layer 6 covers the outer side of the color resin 3 and the black matrix 4;

wherein the touch electrode 2 is completely covered by the black matrix 4.

Similarly, with this structure design, since the black matrix 4 has a good shading light function, the stripe pattern of the touch electrode 2 thus can be shaded, thereby eliminating the visual effect of the stripe pattern from the screen; therefore this solution can improve the display effect of the touch display effectively.

As shown in FIG. 5, in a color film substrate provided by a fifth embodiment of the present invention:

the color resin 3 is located on the inner side of the basal substrate 1;

the spacer 5 is located on the inner side of the color resin 3;

the touch electrode 2 is located on the outer side of the basal substrate 1;

the black matrix 4 is located on the outer side of the touch electrode 2;

the protective layer 6 covers the outer side of the basal substrate 1 and the black matrix 4;

wherein the touch electrode 2 is completely covered by the black matrix 4.

Similarly, with this structure design, since the black matrix 4 has a good shading light function, the stripe pattern of the touch electrode 2 thus can be shaded, thereby eliminating the visual effect of the stripe pattern from the screen; therefore this solution can improve the display effect of the touch display effectively.

As shown in FIG. 6, in a color film substrate provided by a sixth embodiment of the present invention, the black matrix comprises a first shading layer 41 and a second shading layer 42; the color film substrate has the following specific structure:

the touch electrode 2 is located on the outer side of the basal substrate 1;

the first shading layer 41 covers the outer side of the touch electrode 2;

the protective layer 6 covers the outer side of the basal substrate 1 and the first shading layer 41;

the second shading layer 42 is located on the inner side of the basal substrate 1;

the color filter 3 is located on the inner side of the basal substrate 1; and the boundary area of the color filter 3 is shaded by the second shading layer 42;

the spacer 5 is located on the inner side of the color resin 3.

In this embodiment, the function of the second shading layer 42 is shading stray light and avoiding light leakage between the pixels. The function of the first shading layer 41 is shading the stripe pattern of the touch electrode 2, thereby eliminating the visual effect of the stripe pattern from the screen; therefore this solution can improve the display effect of the touch display effectively.

In the above mentioned embodiments of the present invention, when the color film substrate provided by the embodiment of the invention is applied in a touch display, since at least one of the color filter 3 and the black matrix 4 covers an outer side of the touch electrode 2, the stripe pattern of the touch electrode 2 can be alleviated or eliminated from the screen; therefore, the solution can effectively improve the display effect of the touch display. Moreover, since the touch electrode 2 is located on an outer side of the basal substrate 1, the touch sensitivity of the touch display is not affected by the thickness of the basal substrate 1, the solution can also improve the touch sensitivity of the touch display.

An embodiment of the present invention further provides a touch display comprising a color film substrate described in any one of the above mentioned embodiments. The touch display has a better display effect and a higher touch sensitivity.

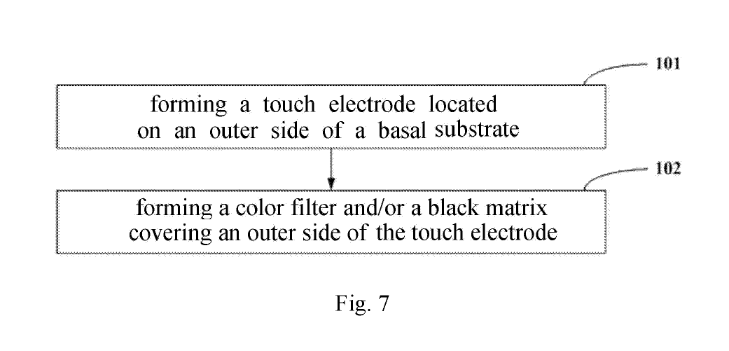

As shown in FIG. 7, a seventh embodiment of the present invention further provides a method for manufacturing a color film substrate, comprising:

step 101: forming a touch electrode located on an outer side of a basal substrate;

step 102: forming a color filter and/or a black matrix covering an outer side of the touch electrode.

When the color film substrate manufactured with the method is applied in a touch display, since at least one of the color filter and the black matrix covers an outer side of the touch electrode, the stripe pattern of the touch electrode can be alleviated or eliminated from the screen; therefore, the solution can effectively improve the display effect of the touch display. Moreover, since the touch electrode is located on an outer side of the basal substrate, the touch sensitivity of the touch display is not affected by the thickness of the basal substrate, the color film substrate manufactured with the above mentioned method can also improve the touch sensitivity of the touch display.

An eighth embodiment of the present invention further provides a method for manufacturing a color film substrate, specifically comprising:

forming a spacer located on an inner side of a basal substrate;

forming a touch electrode located on an outer side of the basal substrate;

forming a color resin located on an outer side of the touch electrode;

forming a black matrix located on an outer side of the color resin;

forming a protective layer covering the outer side of the color resin and the black matrix;

wherein at least one of the color filter and the black matrix covers an outer side of the touch electrode.

The color film substrates shown in FIG. 1 to FIG. 3 can be manufactured with the method provided by the eighth embodiment of the present invention.

A ninth embodiment of the present invention further provides a method for manufacturing a color film substrate, which method can be used for manufacturing the color film substrate shown in FIG. 4; the method specifically comprises:

forming a spacer located on an inner side of a basal substrate;

forming a color resin located on an outer side of the basal substrate;

forming a touch electrode located on an outer side of the color resin;

forming a black matrix located on an outer side of the touch electrode;

forming a protective layer covering the outer side of the color resin and the black matrix.

A tenth embodiment of the present invention further provides a method for manufacturing a color film substrate, which method can be used for manufacturing the color film substrate shown in FIG. 5; the method specifically comprises:

forming a color resin located on an inner side of a basal substrate;

forming a spacer located on an inner side of the color resin;

forming a touch electrode located on an outer side of the basal substrate;

forming a black matrix covering an outer side of the touch electrode;

forming a protective layer covering the outer side of the basal substrate and the black matrix.

A eleventh embodiment of the present invention further provides a method for manufacturing a color film substrate, which method can be used for manufacturing the color film substrate shown in FIG. 6; the method specifically comprises:

forming a second shading layer located on an inner side of the basal substrate;

forming a forming a color resin located on an inner side of a basal substrate; the boundary area of the color filter being shaded by the second shading layer;

forming a spacer located on an inner side of the color filter;

forming a touch electrode located on an outer side of the basal substrate;

forming a first shading layer covering an outer side of the touch electrode;

forming a protective layer covering the outer side of the basal substrate and the first shading layer.

The advantages of the eighth to eleventh embodiments is same with those mentioned above, which will not be repeated herein.

In addition, if a touch display comprises an array substrate and a color film substrate, in the respective method of the above embodiments, after forming the spacer, a box aligning process can then be performed to the array substrate and the color film substrate. In this way, the alignment marks on the array substrate can be used as alignment marks for subsequent related process. With such unified alignment marks, the alignment accuracy can be higher, which is in favor of reducing the designed line width of the black matrix, improving the transmittance of the screen.

Apparently, the skilled person in the art can make various modifications and variations to the present invention without departing from the spirit and scope of the present invention. In this way, provided that these modifications and variations of the present invention belong to the scopes of the claims of the present invention and the equivalent technologies thereof, the present invention also intends to cover these modifications and variations.

1. A color film substrate, comprising: a basal substrate, a touch electrode, a color filter and a black matrix; wherein:
the touch electrode is located on an outer side of the basal substrate; at least one of the color filter and the black matrix covers an outer side of the touch electrode.

2. The color film substrate as claimed in claim 1, wherein the color filter is located on the outer side of the touch electrode; the black matrix is located on the outer side of the color filter.

3. The color film substrate as claimed in claim 1, wherein the color filter is located on the outer side of the basal substrate; the touch electrode is located on the outer side of the color filter; the black matrix covers the outer side of the touch electrode.

4. The color film substrate as claimed in claim 1, wherein the color filter is located on an inner side of the basal substrate; the black matrix covers the outer side of the touch electrode.

5. The color film substrate as claimed in claim 1, wherein the black matrix comprises a first shading layer and a second shading layer, wherein:
the first shading layer covers the outer side of the touch electrode;
the second shading layer is located on an inner side of the basal substrate;
the color filter is located on an inner side of the basal substrate; and the boundary area of the color filter is shaded by the second shading layer.

6. The color film substrate as claimed in claim 1, wherein further comprising: a spacer located on an inner side of a structure formed with the basal substrate, the touch electrode, the color filter and the black matrix; and a protective layer located on an outer side of the structure formed with the basal substrate, the touch electrode, the color filter and the black matrix.

7. A touch display, wherein comprising a color film substrate as claimed in claim 1.

8. A method for manufacturing a color film substrate as claimed in claim 1, wherein comprising:
forming a touch electrode located on an outer side of a basal substrate;
forming a color filter and/or a black matrix covering an outer side of the touch electrode.

9. The method as claimed in claim 8, wherein forming a color filter and/or a black matrix covering an outer side of the touch electrode is forming a color filter covering an outer side of the touch electrode; the method further comprises:
forming a spacer located on an inner side of the basal substrate;
forming a black matrix located on an outer side of the color filter;
forming a protective layer covering the outer side of the color filter and the black matrix;
wherein at least one of the color filter and the black matrix covers the outer side of the touch electrode.

10. The method as claimed in claim 8, wherein forming a touch electrode located on an outer side of a basal substrate comprises forming a color filter located on the outer side of the basal substrate and forming a touch electrode located on an outer side of the color filter; forming a color filter and/or a black matrix covering an outer side of the touch electrode is forming a black matrix covering an outer side of the touch electrode; the method further comprises:
forming a spacer located on an inner side of the basal substrate;
forming a protective layer covering the outer side of the color filter and the black matrix.

11. The method as claimed in claim 8, wherein forming a color filter and/or a black matrix covering an outer side of the touch electrode is forming a black matrix covering an outer side of the touch electrode; the method further comprises:
forming a color filter located on an inner side of the basal substrate;
forming a spacer located on an inner side of the color filter;
forming a protective layer covering the outer side of the basal substrate and the black matrix.

12. The method as claimed in claim 8, wherein forming a color filter and/or a black matrix covering an outer side of the touch electrode is forming a first shading layer covering an outer side of the touch electrode; the method further comprises:
forming a second shading layer located on an inner side of the basal substrate;
forming a color filter located on an inner side of the second shading layer, the boundary area of the color filter being shaded by the second shading layer;
forming a spacer located on an inner side of the color filter;
forming a protective layer covering the outer side of the basal substrate and the first shading layer.

13. The touch display as claimed in claim 7, wherein the color filter is located on the outer side of the touch electrode; the black matrix is located on the outer side of the color filter.

14. The touch display as claimed in claim 7, wherein the color filter is located on the outer side of the basal substrate; the touch electrode is located on the outer side of the color filter; the black matrix covers the outer side of the touch electrode.

15. The touch display as claimed in claim 7, wherein the color filter is located on an inner side of the basal substrate; the black matrix covers the outer side of the touch electrode.

16. The touch display as claimed in claim 7, wherein the black matrix comprises a first shading layer and a second shading layer, wherein:
the first shading layer covers the outer side of the touch electrode;
the second shading layer is located on an inner side of the basal substrate;
the color filter is located on an inner side of the basal substrate; and the boundary area of the color filter is shaded by the second shading layer.

17. The touch display as claimed in claim 7, further comprising: a spacer located on an inner side of a structure formed with the basal substrate, the touch electrode, the color filter and the black matrix; and a protective layer located on an outer side of the structure formed with the basal substrate, the touch electrode, the color filter and the black matrix.
